(19) United States
(12) Patent Application Publication
(10) Pub. No.: US 2025/0192595 A1
(43) Pub. Date: Jun. 12, 2025

(54) ELECTRONIC DEVICE AND POWER SUPPLY METHOD THEREOF

(71) Applicant: ASUSTeK COMPUTER INC., Taipei City (TW)

(72) Inventors: Tzu-Nan Cheng, Taipei City (TW); Hsiang-Jui Hung, Taipei City (TW); Wei-Gen Chung, Taipei City (TW); Hsi-Ho Hsu, Taipei City (TW); Sheng-Wei Hsiao, Taipei City (TW)

(73) Assignee: ASUSTeK COMPUTER INC., Taipei City (TW)

(21) Appl. No.: 18/937,059

(22) Filed: Nov. 5, 2024

(30) Foreign Application Priority Data
Dec. 8, 2023 (TW) 112147840

(51) Int. Cl. H02J 7/04; H02J 7/00

(52) U.S. Cl. CPC H02J 7/04; H02J 7/00034; H02J 7/00309; H02J 7/007192; H02J 2207/20

(57) ABSTRACT

An electronic device and a power supply method thereof are provided. The electronic device includes a host and an adapter. The host includes a charger circuit, a first controller chip and a controller. In a power connection state, the charger circuit receives DC power from the adapter to supply power to a system load within the host. The first controller chip communicates with a second controller chip included in the adapter to obtain an identification code and power supply capability information of the adapter. The controller determines whether the adapter meets a specific specification based on the identification code. When the adapter meets the specific specification, the controller periodically obtains a real-time internal temperature of the adapter from the second controller chip, analyzes it together with the power supply capability information, and establishes a power supply plan suitable for a boost mode.

### CROSS-REFERENCE TO RELATED APPLICATION

This application claims the priority benefit of Taiwan application serial no. 112147840, filed on Dec. 8, 2023. The entirety of the above-mentioned patent application is hereby incorporated by reference herein and made a part of this specification.

### BACKGROUND

### Technical Field

The disclosure relates to an electronic device that may increase the instantaneous power of a DC power according to the specification and the current state of an adapter and the power supply method adopted thereof.

### Description of Related Art

Contemporary consumer electronic products (e.g., laptops, desktop computers, mobile phones, and tablets, etc.) typically rely on direct current (DC) power provided by an adapter for power supply. Generally speaking, the adapter only provides DC power with rated power and does not provide additional power to the system. Therefore, when handling high-load tasks (e.g., executing game programs or quickly charging the battery, etc.), insufficient power supply may occur, reducing its operating performance and resulting in a poor user experience.

### SUMMARY

An electronic device, which includes a host and an adapter, is provided in the disclosure. The host includes a charger circuit, a first controller chip, and a controller. In a power connection state, the charger circuit receives DC power from the adapter to supply power to a system load within the host. In the power connection state, the first controller chip communicates with a second controller chip included in the adapter to obtain an identification code and power supply capability information of the adapter. The controller is coupled to the charger circuit and the first controller chip, and determines whether the adapter meets a specific specification according to the identification code. When the adapter meets the specific specification, the controller periodically obtains a real-time internal temperature of the adapter from the second controller chip, analyzes the real-time internal temperature together with the power supply capability information, and establishes a power supply plan suitable for a boost mode.

A power supply method, adapted for an electronic device including a host and an adapter is provided in the disclosure. The host includes a first controller chip, and the adapter includes a second controller chip. The method includes the following operation. In a power connection state, DC power is received from the adapter to supply power to a system load within the host. In the power connection state, a second controller chip included in the adapter is communicated with to obtain an identification code and power supply capability information of the adapter. Whether the adapter meets a specific specification is determined according to the identification code. When the adapter meets the specific specification, a real-time internal temperature of the adapter is periodically obtained from the second controller chip, analyzed together with the power supply capability information, and a power supply plan suitable for a boost mode is established.

Based on the above, the electronic device and the power supply method thereof of the disclosure may establish a power supply plan suitable for a boost mode according to the power supply capability information and real-time internal temperature of the adapter. In this way, when the electronic device is shifted to the boost mode, the adapter may provide DC power higher than the rated voltage or rated current based on the power supply capability information, power supply demand and the established power supply plan to avoid power supply deficiencies, thereby improving its operational efficiency and improving convenience of use.

In order to make the above-mentioned features and advantages of the disclosure comprehensible, embodiments accompanied with drawings are described in detail below.

### BRIEF DESCRIPTION OF THE DRAWINGS

FIG. 1 is a block schematic diagram of an electronic device according to an embodiment of the disclosure.

FIG. 2 is an example of set standards according to an embodiment of the disclosure.

FIG. 3 is an example of a power supply plan according to an embodiment of the disclosure.

FIG. 4 is an example of a user interface according to an embodiment of the disclosure.

FIG. 5 is a block schematic diagram of an electronic device according to an embodiment of the disclosure.

FIG. 6 is a flowchart of a power supply method according to an embodiment of the disclosure.

FIG. 7 is a flowchart of a power supply method according to an embodiment of the disclosure.

### DETAILED DESCRIPTION OF DISCLOSED EMBODIMENTS

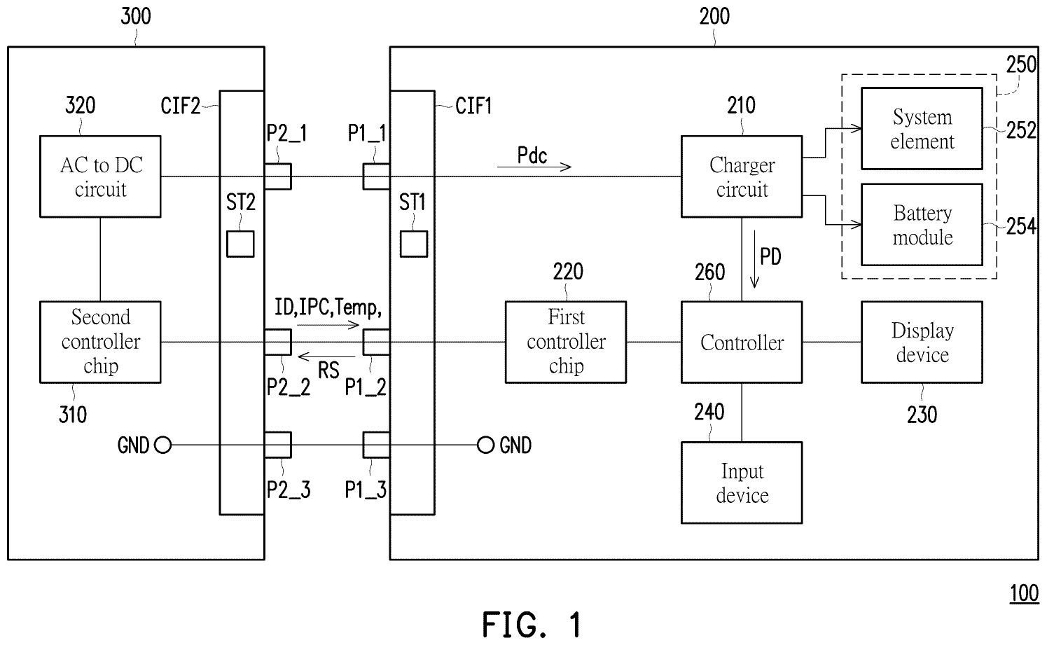

Referring to FIG. 1, the electronic device 100 of this embodiment is, for example, consumer electronic products such as a laptop, a desktop computer, a mobile phone, or a tablet. The electronic device 100 includes a host 200 and an adapter 300. The adapter 300 is, for example, an AC adapter.

In FIG. 1, the host 200 includes a charger circuit 210, a first controller chip 220, a display device 230, an input device 240, a system load 250, and a controller 260. The adapter 300 includes a second controller chip 310 and an AC to DC circuit 320. The first connection interface CIF1 in the host 200 is coupled to the charger circuit 210 and the first controller chip 220. The second connection interface CIF2 in the adapter 300 is coupled to the second controller chip 310.

In this embodiment, when the adapter 300 is inserted into the host 200, the electronic device 100 enters a power connection state indicating that the adapter 300 is connected. The first connection interface CIF1 in the host 200 and the second connection interface CIF2 in the adapter 300 are connected to each other, thereby transmitting direct current (DC) power Pdc between the host 200 and the adapter 300, and the digital signal required for the first controller chip 220 and the second controller chip 310 to communicate with each other according to the communication protocol. In addition, when the adapter 300 is unplugged from the host 200, the electronic device 100 is released from the power connection state.

In addition, the first connection interface CIF1 includes at least three pins P1_1 to P1_3, and the second connection interface CIF2 includes at least three pins P2_1 to P2_3. The pin P1_1 and the pin P2_1 are, for example, VBUS pins, the pin P1_2 and the pin P2_2 are, for example, data transmission pins, and the pin P1_3 and the pin P2_3 are, for example, grounding pins. As shown in FIG. 1, in the power connection state, the pin P1_1 and the pin P2_1 are connected to each other so that the charger circuit 210 is connected to the AC to DC circuit 320 to transmit the DC power Pdc. The pin P1_2 and the pin P2_2 are connected to each other so that the first controller chip 220 and the second controller chip 310 are connected to transmit the digital signals required to communicate with each other according to the communication protocol. The pin P1_3 and the pin P2_3 are connected to each other to couple the ground potential GND in the host 200 and the adapter 300.

In the adapter 300, the AC to DC circuit 320 is coupled to the second controller chip 310 and may be controlled by the second controller chip 310 to rectify and filter the external AC power supply to provide a stable DC power Pdc. The second controller chip 310 may adjust the voltage and current of the DC power Pdc through the AC to DC circuit 320, and may also monitor the power, temperature and power supply time of the DC power Pdc.

In the power connection state, the charger circuit 210 may receive the DC power Pdc from the AC to DC circuit 320 of the adapter 300 to supply power to the system load 250. In this embodiment, the system load 250 includes a system element 252 and a battery module 254. The system element 252 includes, for example, a central processing unit (CPU), a graphics processing unit (GPU), and other various processing chips that are configured on the motherboard of the host 200 and require power supply. The battery module 254 is, for example, embedded or external, and may be configured to store electrical energy to provide battery power to the system element 252.

In the power connection state, the first controller chip 220 may communicate with the second controller chip 310 in the adapter 300 according to the communication protocol to obtain the identification code ID and the power supply capability information IPC of the adapter 300.

The display device 230 is, for example, a display adopting a liquid crystal display (LCD), a light-emitting diode (LED), a field emission display (FED), or other types of panels. The display device 230 may be configured to display the user interface UI.

The input device 240 is, for example, a mouse, a touchpad, or a touch panel with resistive, capacitive, or other types of touch sensing elements, which may be combined with the display device 230 to form a touch display, and may receive the touch operation of the user on the screen displayed by the display device 230.

The controller 260 is, for example, an embedded controller (EC) or a microcontroller. The controller 260 is coupled to the charger circuit 210, the first controller chip 220, the display device 230, and the input device 240. The controller 260 may determine whether the adapter 300 meets the specific specification of the supplier according to the identification code ID. Specifically, the identification code ID includes, for example, a vendor identification code (VID), a product identification code (PID), and a vendor defined message (VDM). One or more unique codes that may support the boost mode (specific specification) of the electronic device 100 are pre-stored in the controller 260. When obtaining the identification code ID of the adapter 300, the controller 260 may compare the identification code ID with the unique code. When the identification code ID matches the unique code, the controller 260 may determine that the adapter 300 meets the specific specification and may support the boost mode of the electronic device 100. When the identification code ID does not match the unique code, the controller 260 may determine that the adapter 300 does not meet the specific specification and cannot support the boost mode of the electronic device 100.

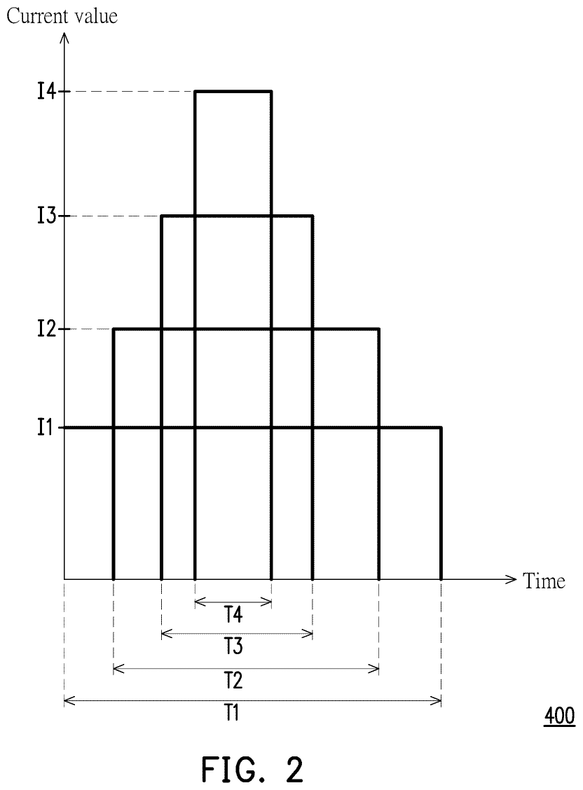

The power supply capability information IPC includes, for example, the set standards for the high voltage value above the rated voltage and the high current value above the rated current that the adapter 300 may provide, as well as the set standards for displaying the relationship of the voltage or current value of the DC power Pdc relative to time. For example, in FIG. 2, the set standards may be a relationship diagram 400 plotted with the current value as the vertical axis and time as the horizontal axis. In the relationship diagram 400, I1 is a current value of the rated current of the adapter 300, I2 is a current value that is 1.2 times the rated current, I3 is a current value that is 1.5 times the rated current, and I4 is a current value 2 times the rated current. As shown in FIG. 2, when the current value of the DC power Pdc is I1, the adapter 300 may provide the DC power Pdc for a time period T1, which represents, for example, an unlimited time period. When the current value of the DC power Pdc is I2, the adapter 300 may provide the DC power Pdc for a time period T2, which represents, for example, 30 minutes. When the current value of the DC power Pdc is 13, the adapter 300 may provide the DC power Pdc for a time period T3, which represents, for example, 10 minutes. When the current value of the DC power Pdc is I4, the adapter 300 may provide the DC power Pdc for a time period T4, which represents, for example, 5 minutes. It may be seen from the relationship diagram 400 that when the current exceeds the rated current, the greater the current provided by the adapter 300, the shorter the time period it may be provided.

The first controller chip 220 may also store the power supply capability information IPC to continuously communicate with the second controller chip 310 under the standards defined by the power supply capability information IPC. Communication may be directly refused in the event of a violation of the standards.

The second controller chip 310 may also monitor whether the present current and voltage of the AC to DC circuit 320 violate the standards defined by the power supply capability information IPC.

When the adapter 300 meets the specific specification, the controller 260 may periodically obtain a real-time internal temperature Temp of the adapter 300 from the second controller chip 310, analyze the real-time internal temperature Temp together with the power supply capability information IPC, and establish a power supply plan suitable for a boost mode. The adapter 300 has a built-in temperature sensor that may sense the internal temperature of the adapter 300. When the adapter 300 meets the specific specification, the controller 260 may periodically transmit the state information request RS to the second controller chip 310 through the first controller chip 220, so that the second controller chip 310 periodically reports state information including the real-time internal temperature Temp to the controller 260.

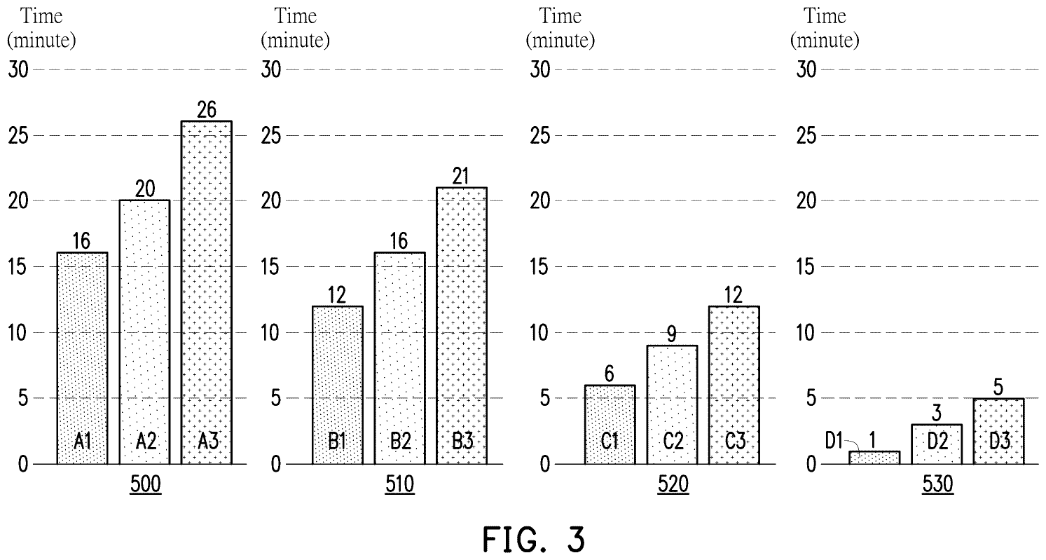

The controller 260 may analyze the received real-time internal temperature Temp of the adapter 300 and the power supply capability information IPC to establish a power supply plan suitable for the boost mode. For example, FIG. 3 illustrates four different power supply plans 500, 510, 520 and 530 established corresponding to different real-time internal temperatures Temp. In this embodiment, the power supply plan 500 is for the real-time internal temperature Temp of 56.6 degrees Celsius, the power supply plan 510 is for the real-time internal temperature Temp of 66.2 degrees Celsius, the power supply plan 520 is for the real-time internal temperature Temp of 80.9 degrees Celsius, and the power supply plan 530 is for the real-time internal temperature Temp of 102 degrees Celsius.

The power supply plan 500 includes three power supply bars A1 to A3 corresponding to three different powers (e.g., 460 watts, 430 watts and 400 watts). As shown in the power supply bars A1 to A3, the power supply bars A1 to A3 respectively represent different allowable power supply durations (e.g., 16 minutes, 20 minutes and 26 minutes). When the real-time internal temperature Temp received by the controller 260 is expressed as 56.6 degrees Celsius, the electronic device 100 may be planned to operate according to the power time allocation rule defined by the power supply plan 500 and operate for 16 minutes at 460 watts, 20 minutes at 430 watts, and 26 minutes at 400 watts.

Similarly, the power supply plans 510, 520, and 530 also include three power supply bars B1 to B3, C1 to C3, and D1 to D3 corresponding to three different powers (e.g., 460 watts, 430 watts, and 400 watts). In the case where the real-time internal temperature Temp received by the controller 260 is expressed as 66.2 degrees Celsius, 80.9 degrees, or 102 degrees Celsius, the electronic device 100 may be planned to operate according to the power time allocation rule defined by the power supply plan 510, 520 or 530. The controller 260 may update the currently used power supply plan in real time as the obtained real-time internal temperature Temp changes.

Based on this, when the electronic device 100 is in the boost mode, the controller 260 may obtain the power supply demand PD required by the system load 250 from the charger circuit 210, and issue commands to the second controller chip 310 through the first controller chip 220 to control the AC to DC circuit 320 to provide a DC power Pdc higher than the rated voltage or rated current based on the power supply capability information IPC, the power supply demand PD and the power supply plan established corresponding to the current state.

At the same time, the controller 260 may control the charger circuit 210 according to the power supply demand PD and the power supply plan to allocate the DC power Pdc to supply power to the system element 252 and the battery module 254. For example, when executing a game program, the controller 260 may allocate a higher proportion of DC power Pdc to the system element 252, and when fast charging the battery module 254, the controller 260 may allocate a higher proportion of the DC power Pdc to the battery module 254, thereby adjusting the power allocation proportion according to present requirements, and providing a better user experience.

It should be noted that, in order to facilitate understanding, four power supply plans are used for explanation in this embodiment, but the disclosure is not limited thereto. Those skilled in the art may derive more power supply plans for different real-time internal temperatures Temp according to the teachings of the disclosure and actual requirements.

In FIG. 1, the host 200 also includes a first temperature sensor ST1. The adapter 300

also includes a second temperature sensor ST2. The first temperature sensor ST1 is disposed on the first connection interface CIF1 and may be configured to sense the temperature of the first connection interface CIF1. The second temperature sensor ST2 is disposed on the second connection interface CIF2 and may be configured to sense the temperature of the second connection interface CIF2. In one embodiment, when the temperature of the first connection interface CIF1 or the second connection interface CIF2 is greater than the temperature threshold (e.g., indicating an abnormality occurs), the controller 260 may issue a command to the second controller chip 310 through the first controller chip 220 to control the AC to DC circuit 320 to stop providing the DC power Pdc, so that the adapter 300 stops operating.

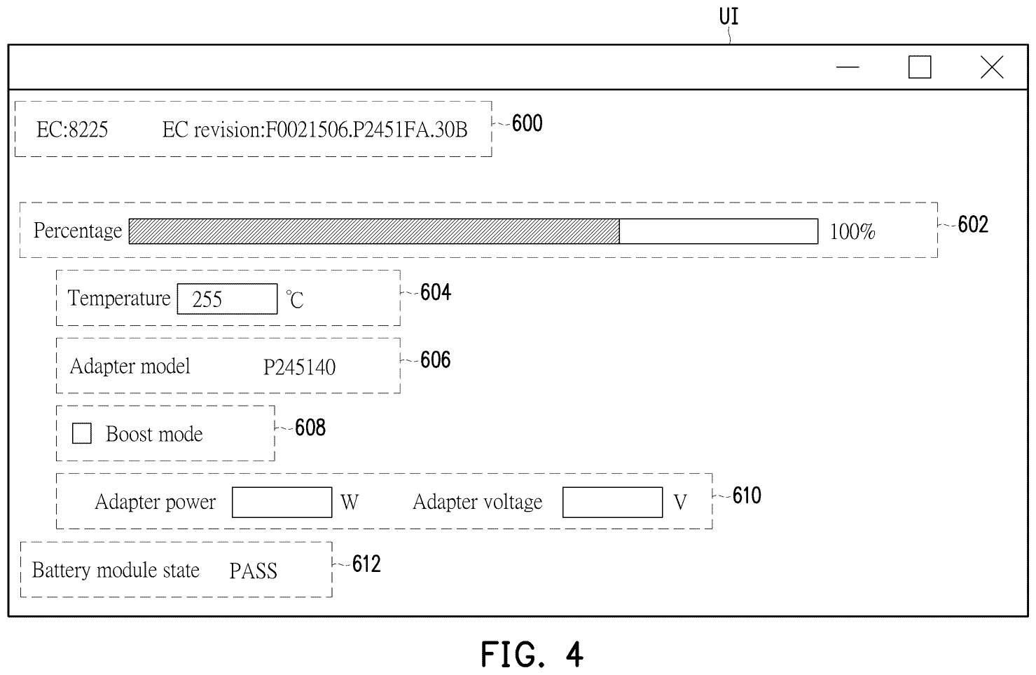

The following example illustrates how to shift the electronic device 100 from the normal mode to the boost mode. The controller 260 may display the user interface UI through the display device 230, thereby providing the user with information related to power supply obtained by the first controller chip 220, the second controller chip 310 and other components, so that the user may monitor the power supply state of the electronic device 100 in real time. As shown in FIG. 4, the user interface UI includes controller model and revision information 600, relative state of charge (RSOC) information 602, internal temperature information 604, adapter model information 606, boost mode option 608, adapter power and voltage information 610, and battery module state information 612. The controller 260 may display the real-time internal temperature Temp received from the second controller chip 310 through the internal temperature information 604 on the user interface UI of the display device 230.

At this time, the input device 240 may receive a selection operation from the user to select the boost mode option 608 in the user interface UI. When the boost mode option 608 is selected by the user, the controller 260 may shift the electronic device 100 from the normal mode to the boost mode, so that the adapter 300 provides a DC power Pdc higher than the rated voltage or rated current based on the power supply capability information IPC, the power supply demand PD and the power supply plan established corresponding to the current state.

In one embodiment, the controller 260 may also automatically shift the electronic device 100 from the normal mode to the boost mode directly according to the power supply demand required by the system load 250.

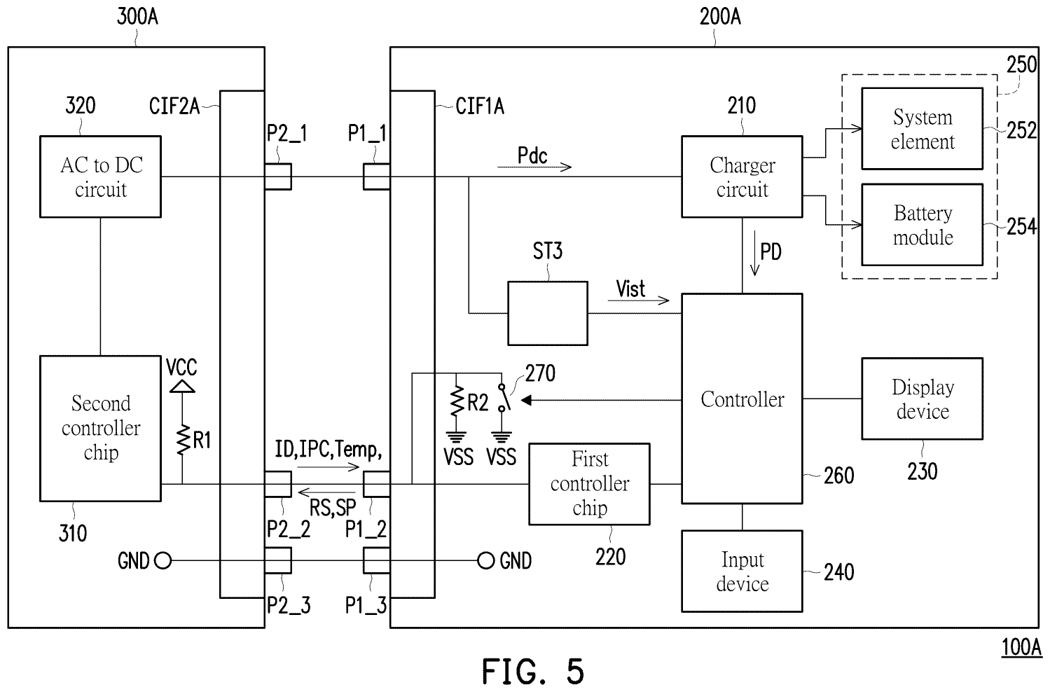

Referring to FIG. 5, in one embodiment, the electronic device 100A includes a host 200A and an adapter 300A. The host 200A includes a charger circuit 210, a first controller chip 220, a display device 230, an input device 240, a system load 250, and a controller 260. The adapter 300A includes a second controller chip 310 and an AC to DC circuit 320. The above elements are the same or similar to the elements in the host 200 and the adapter 300 of the previous embodiment, so the detailed functions thereof are not repeated herein.

Different from the previous embodiment, the adapter 300A also includes a resistor R1. The host 200A also includes a third temperature sensor ST3, a switch circuit 270 and a resistor R2. The first terminal of the resistor R1 is coupled to the power supply voltage VCC, and the second terminal of the resistor R1 is coupled to the second controller chip 310. In the power connection state, the second terminal of the resistor R1 may be coupled to the first terminal of the resistor R2 through the pin P2_2 on the second connection interface CIF2A and the pin P1_2 on the first connection interface CIF1A. The second terminal of the resistor R2 is coupled to the power supply voltage VSS. In this embodiment, the power supply voltage VCC is greater than the power supply voltage VSS, the power supply voltage VCC is, for example, 3 volts, and the power supply voltage VSS is, for example, 0 volts.

The third temperature sensor ST3 is coupled to the first connection interface CIF1A and the controller 260. The third temperature sensor ST3 includes a thermistor. In the power connection state, the thermistor of the third temperature sensor ST3 starts sensing the temperature of the first connection interface CIF1A, and provides the real-time voltage Vist to the controller 260, so that the controller 260 may convert it into the real-time temperature of the first connection interface CIF1A.

In the power connection state, the switch circuit 270 and the resistor R2 are connected in parallel between the second terminal of the resistor R1 and the power supply voltage VSS. The switch circuit 270 is also coupled to the controller 260. The switch circuit 270 is controlled by the controller 260 to be turned on or off. When the temperature of the first connection interface CIF1A does not exceed the temperature threshold, the controller 260 keeps the switch circuit 270 turned off. At this time, the protection signal Sp received by the second controller chip 310 is at a high logic level.

When the temperature of the first connection interface CIF1A is greater than the temperature threshold (e.g., indicating an abnormality occurs), the controller 260 turns on the switch circuit 270. In this way, the protection signal Sp pulled down to a low logic level may be provided to the second controller chip 310 through the first connection interface CIF1A and the second connection interface CIF2A to control the AC to DC circuit 320 to stop providing the DC power Pdc, so that the adapter 300A stops operating. In this way, the operation of high temperature protection is achieved.

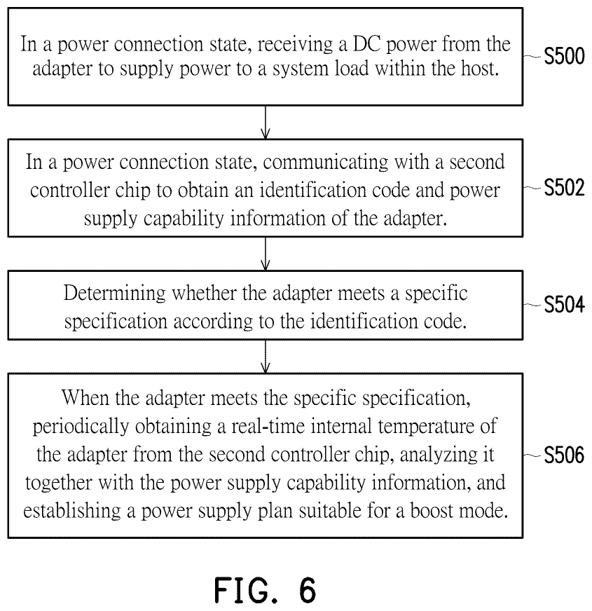

The controller 260 may load stored firmware to execute the power supply method of the disclosure. The power supply method of this embodiment may be suitable for the electronic device 100 of FIG. 1 and the electronic device 100A of FIG. 5. The following description takes the electronic device 100 of FIG. 1 as an example. Referring to FIG. 1 and FIG. 6 at the same time, the power supply method includes the following steps. In the power connection state, the charger circuit 210 receives the DC power Pdc from the adapter 300 to supply power to the system load 250 within the host 200 (step S500). In the power connection state, the first controller chip 220 communicates with the second controller chip 310 to obtain the identification code ID and power supply capability information IPC of the adapter 300 (step S502). The controller 260 determines whether the adapter 300 meets the specific specification according to the identification code ID (step S504). When the adapter meets the specific specification, the controller 260 periodically obtains a real-time internal temperature Temp of the adapter 300 from the second controller chip 310, analyzes the real-time internal temperature Temp together with the power supply capability information IPC, and establishes a power supply plan suitable for a boost mode. For the implementation details of the above steps S500, S502, S504 and S506, reference may be made to the embodiment content of FIG. 1 to FIG. 4, and details are not described herein again.

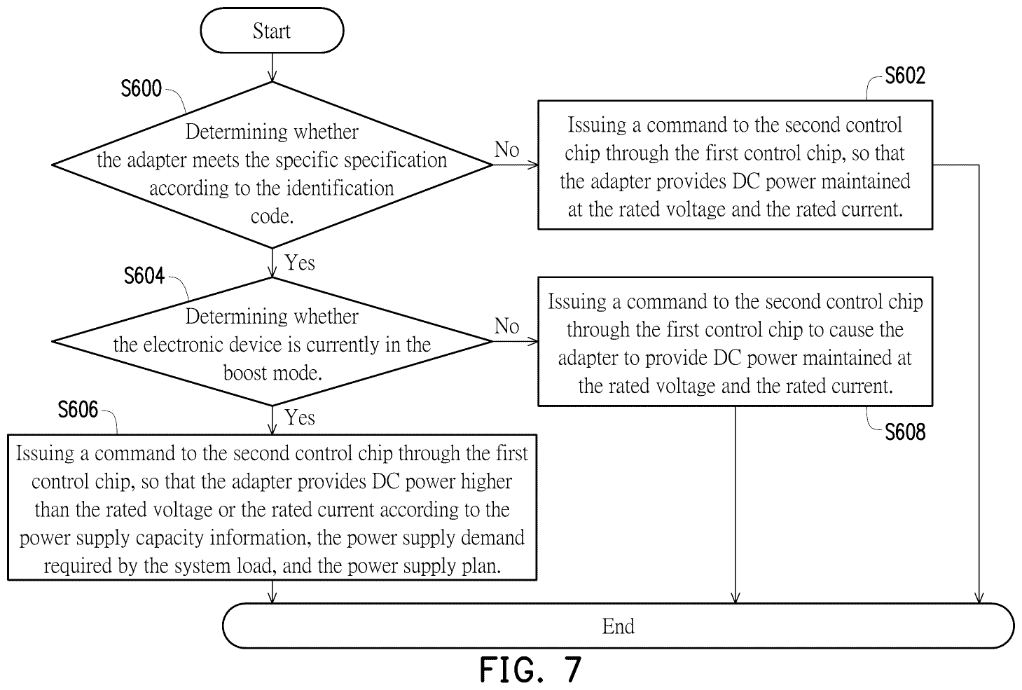

The power supply method of the disclosure is described below with another embodiment. The power supply method of this embodiment may be suitable for the electronic device 100 of FIG. 1 and the electronic device 100A of FIG. 5. The following description takes the electronic device 100 of FIG. 1 as an example. Referring to FIG. 1 and FIG. 7 at the same time, the steps are described as follows.

First, in step S600, the controller 260 determines whether the adapter 300 meets the specific specification according to the identification code ID of the adapter 300.

If the adapter 300 does not meet the specific specification, it indicates that the adapter 300 cannot support the boost mode of the electronic device 100, and the electronic device 100 may only remain in the normal mode. In step S602, the controller 260 issues a command to the second controller chip 310 through the first controller chip 220 to control the AC to DC circuit 320 to provide a DC power Pdc maintained at a rated voltage (e.g., 20 volts) and a rated current (e.g., 12 amps).

If the adapter 300 meets the specific specification, it indicates that the adapter 300 may support the boost mode of the electronic device 100. In step S604, the controller 260 determines whether the electronic device 100 is currently in the boost mode.

When the electronic device 100 is in the boost mode, in step S606, the controller 260 issues a command to the second controller chip 310 through the first controller chip 220 to control the AC to DC circuit 320 to provide a DC power Pdc higher than the rated voltage or rated current based on the power supply capability information IPC of the adapter 300, the power supply demand PD required by the system load 250, and the power supply plan established corresponding to the current state. For example, when the electronic device 100 is in the boost mode, the controller 260 may control the AC to DC circuit 320 to increase one of the voltage and current of the DC power Pdc (e.g. increasing the voltage to 22 volts or increasing the current to 15 amps).

When the electronic device 100 is not in the boost mode, in step S608, the controller 260 issues a command to the second controller chip 310 through the first controller chip 220 to control the AC to DC circuit 320 to provide a DC power Pdc maintained at a rated voltage and a rated current.

To sum up, the electronic device and the power supply method thereof of the disclosure may periodically obtain the real-time internal temperature of the adapter when the adapter meets the specific specification, analyze the real-time internal temperature together with the power supply capability information of the adapter, and establish a power supply plan suitable for a boost mode. In this way, when the electronic device is shifted to the boost mode, the adapter may provide DC power higher than the rated voltage or rated current based on the power supply capability information, power supply demand and the established power supply plan to avoid power supply deficiencies, thereby improving its operational efficiency and improving convenience of use.

What is claimed is:

1. An electronic device, comprising a host and an adapter, the host comprising:
a charger circuit, in a power connection state, receiving DC power from the adapter to supply power to a system load within the host;
a first controller chip, in the power connection state, communicating with a second controller chip comprised in the adapter to obtain an identification code and power supply capability information of the adapter; and
a controller, coupled to the charger circuit and the first controller chip, and determining whether the adapter meets a specific specification according to the identification code, wherein when the adapter meets the specific specification, the controller periodically obtains a real-time internal temperature of the adapter from the second controller chip, analyzes the real-time internal temperature together with the power supply capability information, and establishes a power supply plan suitable for a boost mode.

2. The electronic device according to claim 1, wherein the adapter comprises an AC to DC circuit, the AC to DC circuit is coupled to the second controller chip,
when the adapter does not meet the specific specification, the controller issues a command to the second controller chip through the first controller chip to control the AC to DC circuit to provide the DC power maintained at a rated voltage and a rated current.

3. The electronic device according to claim 2, wherein when the adapter meets the specific specification, the controller determines whether the electronic device is currently in the boost mode,
when the electronic device is in the boost mode, the controller issues a command to the second controller chip through the first controller chip to control the AC to DC circuit to provide the DC power higher than the rated voltage or the rated current based on the power supply capability information, power supply demand required by the system load, and the power supply plan,
when the electronic device is not in the boost mode, the controller issues a command to the second controller chip through the first controller chip to control the AC to DC circuit to provide the DC power maintained at the rated voltage and the rated current.

4. The electronic device according to claim 1, wherein the controller updates the currently used power supply plan in real time as the obtained real-time internal temperature changes.

5. The electronic device according to claim 1, wherein the power supply plan comprises a plurality of allowable power supply durations respectively corresponding to a plurality of different powers.

6. The electronic device according to claim 1, wherein the system load comprises a system element and a battery module,
when in the boost mode, the controller obtains power supply demand required by the system load from the charger circuit, and controls the charger circuit according to the power supply demand and the power supply plan to allocate the DC power to supply power to the system element and the battery module.

7. The electronic device according to claim 1, wherein the host further comprising:
a display device, coupled to the controller, configured to display a user interface,
wherein, the controller displays the real-time internal temperature on the user interface through the display device.

8. The electronic device according to claim 7, wherein the host further comprises:
an input device, coupled to the controller, configured to receive a selection operation to select a boost mode option in the user interface, so that the electronic device shifts from a normal mode to the boost mode.

9. The electronic device according to claim 1, wherein the controller causes the electronic device to shift from a normal mode to the boost mode according to power supply demand required by the system load.

10. The electronic device according to claim 1, wherein the host further comprises:
a first connection interface, coupled to the charger circuit and the first controller chip,
the adapter further comprises:
a second connection interface, coupled to the second controller chip, connected to the first connection interface in the power connection state, thereby transmitting the DC power and a digital signal required for the first controller chip and the second controller chip to communicate to each other between the host and the adapter.

11. The electronic device according to claim 10, wherein the host further comprises:
a first temperature sensor, disposed on the first connection interface, configured to sense temperature of the first connection interface,
the adapter further comprises:
a second temperature sensor, disposed on the second connection interface, configured to sense temperature of the second connection interface,
when the temperature of the first connection interface or the second connection interface is greater than a temperature threshold, the controller issues a command to the second controller chip through the first controller chip, so that the adapter stops operating.

12. The electronic device according to claim 10, wherein the host further comprises:
a third temperature sensor, coupled to the controller and the first connection interface, configured to sense temperature of the first connection interface; and
a switch circuit, coupled to the controller and the first connection interface, controlled by the controller to be turned on or off,
when the temperature of the first connection interface is greater than a temperature threshold, the controller turns on the switch circuit, so that a corresponding protection signal is provided to the second controller chip through the first connection interface and the second connection interface, so that the adapter stops operating.

13. A power supply method, adapted for an electronic device comprising a host and an adapter, the host comprising a first controller chip, the adapter comprising a second controller chip, the power supply method comprising:
receiving DC power from the adapter in a power connection state to supply power to a system load within the host;
obtaining an identification code and power supply capability information of the adapter in the power connection state by communicating with the second controller chip;
determining whether the adapter meets a specific specification according to the identification code; and
periodically obtaining a real-time internal temperature of the adapter from the second controller chip, analyzing together with the power supply capability information, and establishing a power supply plan suitable for a boost mode when the adapter meets the specific specification.

14. The power supply method according to claim 13, wherein determining whether the adapter meets the specific specification according to the identification code, further comprises:
issuing a command to the second controller chip through the first controller chip, so that the adapter provides the DC power maintained at a rated voltage and a rated current when the adapter does not meet the specific specification.

15. The power supply method according to claim 14, wherein determining whether the adapter meets the specific specification according to the identification code, further comprises:
determining whether the electronic device is currently in the boost mode when the adapter meets the specific specification;
issuing a command to the second controller chip through the first controller chip when the electronic device is in the boost mode, so that the adapter provides the DC power higher than the rated voltage or the rated current based on the power supply capability information, power supply demand required by the system load, and the power supply plan,
issuing a command to the second controller chip through the first controller chip when the electronic device is not in the boost mode, so that the adapter provides the DC power maintained at the rated voltage and the rated current.

16. The power supply method according to claim 13, further comprising:
wherein the controller updates the currently used power supply plan in real time as the obtained real-time internal temperature changes.

17. The power supply method according to claim 13, wherein the power supply plan comprises a plurality of allowable power supply durations respectively corresponding to a plurality of different powers.

18. The power supply method according to claim 13, wherein the system load comprises a system element and a battery module, the power supply method further comprises:
obtaining power supply demand required by the system load when in the boost mode, and allocating the DC power according to the power supply demand and the power supply plan to supply power to the system element and the battery module.

19. The power supply method according to claim 13, wherein the host further comprises a display device configured to display a user interface, the power supply method further comprises:
displaying the real-time internal temperature on the user interface through the display device.

20. The power supply method according to claim 19, wherein the host further comprises an input device, the power supply method further comprises:
receiving a selection operation through the input device to select a boost mode option in the user interface, so that the electronic device shifts from a normal mode to the boost mode.

21. The power supply method according to claim 13, wherein the host further comprises a first connection interface, the adapter further comprises a second connection interface, the first connection interface is connected to the second connection interface in the power connection state, thereby transmitting the DC power and a digital signal required for the first controller chip and the second controller chip to communicate to each other between the host and the adapter, the power supply method further comprises:
issuing a command to the second controller chip through the first controller chip when temperature of the first connection interface or the second connection interface is greater than a temperature threshold, so that the adapter stops operating.
